(19) United States
(12) Patent Application Publication
(10) Pub. No.: US 2006/0052532 A1
(43) Pub. Date: Mar. 9, 2006

(54) Swellable, easily cross-linked, essentially linear polymers, and the use of the same in solid phase synthesis

(76) Inventor: Jorg Rademann, Berlin (DE)

Correspondence Address: NATH & ASSOCIATES, 112 South West Street, Alexandria, VA, 22314, US

(21) Appl. No.: 10/532,214

(22) PCT Filed: Apr. 9, 2003
(86) PCT No.: PCT/EP03/03699

§ 371 Date: Apr. 22, 2005

(30) Foreign Application Priority Data
Apr. 10, 2002 (DE) 102 16 513.0

(51) Int. Cl. C08F 8/00

(52) U.S. Cl. 525/61

(57) ABSTRACT

The invention relates to a novel polymer compound, the use of the same and a method for solid phase synthesis using an inventive polymer compound. Said polymer compound comprises linear polymer chains of general formula [R—X]n, wherein R represents a hydrocarbon group and X represents a group comprising at least one heteroatom. The linear polymer chains are cross-linked with each other by means of linking groups.

The invention relates to a novel polymeric compound composed of linear polymer chains. The invention further relates to the use of said polymeric compound and to a method of solid phase synthesis.

The use of insoluble polymeric supports for chemical transformations is among the most important and most far-reaching innovations in organic chemistry in recent decades [1]. The method had a great influence because it not only revolutionized the synthesis of peptides, oligonucleotides, heterocycles and other classes of molecules, but additionally stimulated the development of combinatorial methods for chemistry and biochemistry [2]. In recent years, polymeric supports have also been widely used in solid phase-assisted synthesis in solution [3].

To date, most solid phase-assisted chemistry has been carried out on crosslinked swellable polymer gels. Polystyrene gels are used in most cases [4]. If the resin is required to have higher polarity, polystyrene grafted with polyethylene glycol (PEG) is preferred [5]. Crosslinking of PEG chains results in biocompatible supports which can be penetrated by small and medium-sized biological macromolecules [6].

A substantial disadvantage of current methods is the low atom economy [7] of solid phase-assisted chemistry with conventional resins [8] compared with synthesis in solution, which excludes polymer-assisted methods from many resource- and cost-intensive applications such as, for example, upscaling projects. Low atom economy in this connection means a small amount of product per amount of resin employed. The atom economy of polymer-assisted reactions can be increased considerably when the loading of the polymeric support with reactive functionalizable groups is increased. Polystyrene resins, for example, are additionally restricted in relation to the choice of solvent, the thermal and chemical stability and by the strong adsorption of reagents [9].

It is an object of the present invention to produce a polymeric compound which has, especially in relation to atom economy, improved properties compared with prior art polymeric compounds.

This object is achieved by a polymeric compound composed of linear polymer chains having the general formula —[R—X]—ₙ, in which R is a hydrocarbon group, and X is a group having at least one heteroatom, where the linear polymer chains are crosslinked together via linking groups. Preferred embodiments are to be found in dependent claims 2 to 18. The invention further relates to the subject matters of use claims 19 to 29 and of the process claim 30. The wording of all the claims is hereby incorporated in this description by reference.

The maximally achievable loading of a polymeric compound is limited by the molecular weight of the functionalizable monomer. The maximum loading of, for example, polyethyleneimine (PEI) [10] is therefore 23 mmol/g. This loading is distinctly higher than that of compounds described to date for solid phase synthesis. Crosslinking of highly branched polymers such as, for example, of highly branched PEI are unsuitable, or suitable only with limitation, for solid phase synthesis for two reasons. First, statistically about every 3rd to 3.5th nitrogen is a tertiary branching point and thus not available for derivatization (ref.: Handbook of Polymer Science, 1988). Secondly, the accessibility of all reactive groups in PEI is reduced through the high degree of branching. However, only the crosslinking of branched PEIs is described in the prior art (E. J. Shepherd, J. A. Kitchener, J. Chem. Soc. 1957, 86-92; S. Nonogaki, S. Makishima, Y. Yoneda, J. Phys. Chem. 1958, 62, 601-603; B. L. Rivas et al., Polym. Bull. 1984, 12, 393-397; B. L. Rivas et al., Polym. Bull. 1986, 16, 299-303; B. L. Rivas et al., Polym. Bull. 1992, 28, 601-606). The described PEI resins have been used exclusively as ion exchangers, specifically for removing heavy metal ions. An application for polymer-assisted synthesis is not described therein.

Owing to the fact that the inventive polymeric compound is composed of linear polymer chains which are crosslinked together via linking groups, it is possible to control the degree of crosslinking and thus prepare resins suitable for synthesis.

In addition, a high loadability of the polymeric compound is achieved thereby, because the groups not used for crosslinking are still reactive and therefore in particular can also be chemically derivatized, leading to a drastic increase in the abovementioned atom economy.

Linear polymer chains in the sense of the application are intended also to mean slightly branched polymer chains which a degree of branching which is below the branching density to be expected statistically. These include for example short-chain polyethyleneimines which, with a molecular weight of 200 or 400 dalton, have a degree of branching of about 1 to about 1.5 branching points per linear polymer chain. This derives from the fact that commercially available linear starting materials, for example polyethyleneimines (Aldrich No. 46,853-3), also have a degree of branching of about 1.5 per chain. The degree of branching, for example of the polyethyleneimines, can be determined by ¹³C or ¹H NMR spectroscopy. Determination by ¹H NMR is preceded by peracetylation of the polymer.

The inventive polymeric compound is particularly preferably a substantially insoluble, in particular gel-like, resin. This insolubility is a precondition for the use of the inventive polymeric compound in solid phase synthesis and polymer-assisted synthesis in solution. The resin is particularly preferably a swellable resin. This swellability makes it possible for dissolved molecules to penetrate into the resin, it then being possible for reactions to take place in the interior of the resin.

In a particularly preferred variant of the inventive polymeric compound, the linking groups crosslink the linear polymer chains via their heteroatoms.

With advantage only a part, preferably less than 30%, more preferably less than 15%, in particular about 12%, of the heteroatoms are connected to linking groups, and most of them are available for further derivatizations. The effect of this is in particular the abovementioned great increase in loadability and synthetic availability of the resin. R in the inventive polymeric compound is preferably an alkyl group, preferably a C1-C6-alkyl group, in particular a linear (unbranched) alkyl group. R is particularly preferably an ethylene group (CH₂—CH₂ group).

X in the inventive polymeric compound can be selected from the group consisting of: N⁺—R¹R², O, S, CH—R²—NH₂, CH—SH, CH—R²—SH. X in the inventive polymeric compound is preferably selected from the group consisting of NH, N—R¹, CH—NH₂, CH—OH, CH—R²—OH, in which R¹ and R² are selected from the group consisting of alkyl, cycloalkyl, aryl and benzyl.

R² is preferably a C1-C6-alkyl group, in particular a methylene group. X is particularly preferably NH.

In a particularly preferred embodiment of the inventive polymeric compound, the polymer chains are polyethyleneimine chains. In another preferred embodiment, the polymer chains are polyvinylamine chains.

It is advantageous for the linking groups to be derived from at least one compound selected from the group consisting of polyaldehydes, active polycarboxylic acids, isocyanates, isothiocyanates, dihalides, epoxides, ketenes and epichlorohydrin. The linking groups are particularly preferably derived from at least one polyaldehyde, preferably from an aromatic polyaldehyde. Polyaldehydes generate the resin structure via a thermodynamically controlled equilibrium reaction. They allow the resins to be prepared by reliable synthetic protocols from favorable and easily obtainable starting materials. The linking groups are very particularly preferably derived from a dialdehyde, preferably from an aromatic dialdehyde, in particular from terephthalaldehyde.

Another conceivable variant is one where the linking group is derived from a trialdehyde. In this case, the linkage points would be C atoms.

A particularly preferred variant of the inventive polymeric compound is composed of linear polyethyleneimine crosslinked with terephthalaldehyde. The product of the condensation of linear polyethyleneimine with terephthalaldehyde is preferably in reduced form (compare description of the preferred embodiments). This particularly preferred variant is preferably substantially free of primary amino groups.

It is also possible for the linking groups to be derived from at least one dihalide, preferably from the compounds 1,4-dibromomethylbenzene, 1,4-dichloromethylbenzene, 1,6-dibromo(dichloro)hexane and 1,7-dibromo(dichloro)heptane.

It is advantageous for the inventive polymeric compound to have a loading with reactive groups, especially amino functionalities, of about 10 to about 25 mmol/g, preferably about 15 mmol/g.

It is advantageous for the inventive polymeric compound to be in the form of resin micropellets. These resin micropellets preferably have a particular, approximately identical size. The appropriate sizes are known to the skilled worker.

A wide variety of solid phase syntheses are possible with the inventive polymeric compound. Thus, the inventive polymeric compound is suitable for example for synthesizing peptides and proteins. The inventive compound can also be used to synthesize heterocycles. Besides solid phase synthesis, the inventive polymeric compound is also suitable for polymer-assisted synthesis in solution. It is possible during the latter synthesis to prepare for example polymeric reagents such as polymeric oxidizing agents. Ion exchangers can also be prepared with the inventive compound.

The inventive compound is also suitable for immobilizing enzymes. Reactive supports based on polyethyleneimine are described in the prior art for immobilizing enzymes (Georg Manneke, Sabine Heydolph, Makromol. chem. 182, 2641 to 2657). These described reactive supports are also composed of branched-chain polyethyleneimines.

The inventive compound is likewise suitable for immobilizing substrates which are reacted with enzymes. For example, a peptide which has been synthesized by a peptide synthesis on the ultra resin can be cleaved by the action of an enzyme in a buffer. ULTRA resins mean in this connection the inventive resins which have been highly loaded with reactive groups. Thus, for example, a peptide is synthesized on a 4-hydroxymethylbenzoic acid linker (HMBA) by standard Fmoc chemistry on the resin. After removal of the side-chain protective groups, the peptide is cleaved by the action of a protease, e.g. of trypsin, subtilisin or papain.

The inventive polymeric compound is also very suitable as carrier for pharmacological active ingredients.

The inventive compound is also suitable directly or after modification for use as scavenger, i.e. as trapping resin to remove excess reagents, in particular acid chlorides, isocyanates and further electrophiles. The modified inventive compound preferably consists for this use of secondary and tertiary amines.

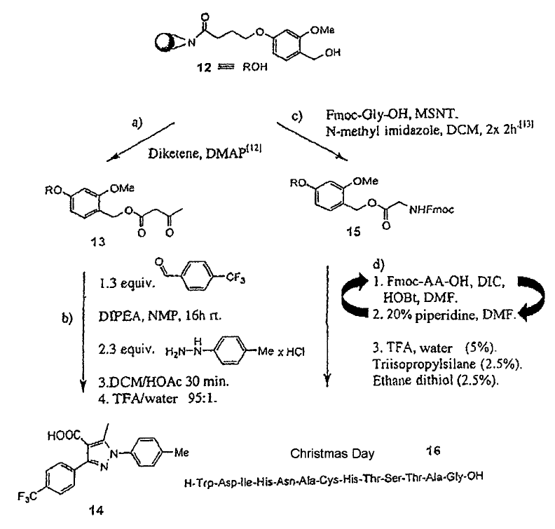

The inventive method for solid phase synthesis is characterized in that an inventive polymeric compound is provided with a suitable linker and then the compound to be synthesized is assembled stepwise on this linker. Possible linkers are Wang-type similar linkers (see FIG. 3, molecule 12), Fmoc Rink linkers, 2-acetoxyacetyl chloride, succinic anhydride or trimellitic anhydride chloride.

Further details and features of the invention are evident from the following description of the preparation of the inventive compound and of preferred embodiments in conjunction with the dependent claims. It is possible in this connection for the respective features to be implemented severally or jointly in plural combination.

The drawings show:

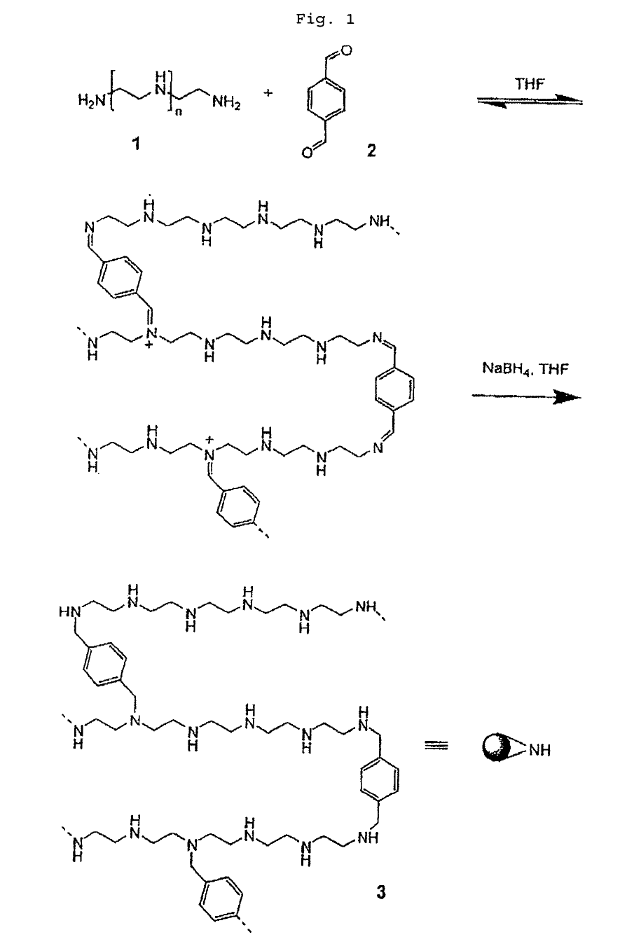

FIG. 1: Preparation of the inventive resin 3 starting from linear polyethyleneimine 1 and terephthalaldehyde 2.

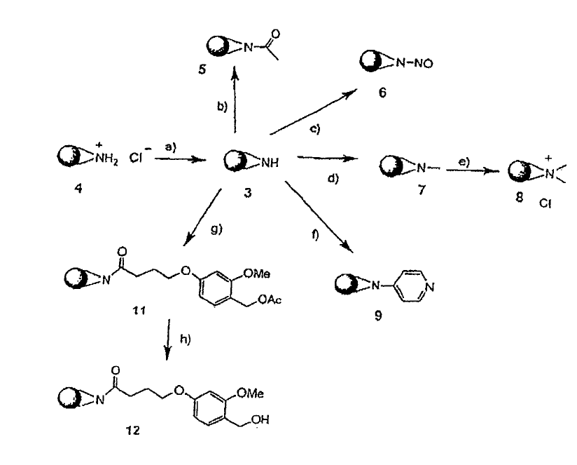

FIG. 2: Synthetic availability of the compound 3 investigated by various chemical derivatizations.

FIG. 3: Synthesis of pyrazolecarboxylic acids and peptides on linker-functionalized resin 12.

### EXPERIMENTAL DETAILS AND EXAMPLES

I. Synthesis and characterization of inventive compounds 3 and 4

The precursors of the inventive compound 3 are linear polyethyleneimine 1 and terephthalaldehyde 2 (FIG. 1).

Elemental Analysis of the Compound 1 Gave the Following Results:

Elemental analysis: C 53.1, H 11.9, N 34.5. C/N=1.54. The degree of polymerization (n) was calculated from the C/N ratio (n=0.583/(N/C-0.583)) and was 8.74, equivalent to an average molecular weight of Mₙ=393.5 gmol⁻¹ (Mₙ=43.07n+17.03). Mₙ was stated by the manufacturer to be 423 gmol⁻¹.

Preparation of Resin 3:

Linear polyethyleneimine 1 (4.17 g, Aldrich, Mₙ=393.5 gmol⁻¹, n=8.74, 10.6 mmol, 103.2 mmol of amine) was dissolved in THF (5 ml) in a 50 ml round-bottom flask equipped with a magnetic stirrer. Terephthalaldehyde 2 (2.38 g, 17.7 mmol) was quickly added in THF (17.5 ml of solution). After 30 s, the flask had warmed to 40° C., after another 4 min the viscosity had increased to such extent that the stirring bar could no longer rotate freely, and after 6 min the stirrer was at a standstill. The initially transparent polymer gel slowly became cloudy after 10 min. 3 h after the start of the reaction, the polymer was comminuted in a porcelain mortar and treated in a glass beaker without stirring with NaBH₄ (1 g in 100 ml of dry MeOH) for 1 h. Water (100 ml) was then added, and the polymer was filtered and washed with 1 M HCl and THF. The polymer was extruded through a metal screen (400 μm pores) with addition of MeOH, and the resulting micropellets of defined size (4.8 g) were washed again on a porcelain filter (P3, about 40 μm max. pore size) (THF, DCM). The hydrochloride resin 3 [11] was converted into the free amine resin 4 by swelling with 2 M NaOH, followed by washing with water, 20% triethylamine in DMF, THF, and DCM.

Spectroscopic analysis of the resin was carried out with FT-ATR-IR, ¹³C suspension NMR and with ¹H magic angle spinning (MAS) suspension NMR spectrometry. The absence of aldehyde, alcohol and primary amino functions in the polymer network 3 demonstrates the complete crosslinking and reduction of the imines. The ratio of PEI to crosslinking aromatic (1.55) was derived from the integrated ¹H spectrum and was only slightly reduced compared with the initial mixture. The ratio of secondary to tertiary amines in 3 was calculated from the PEI/crosslinker ratio and was 8:1.

3: ¹H-NMR (250 MHz, D₂O, HR-MAS with 4500 Hz rotation: δ=2.7-3.5 ppm (m, PEI-CH₂, rel. integration 100), 4.31 (bs, N—CH₂-aryl, 14.6), 7.4-7.6 (bs, aryl-H, 17.7). FT-ATR-IR: δ=1443, 1590, 2768, 2950, 3371 cm⁻¹.

Elemental analysis: C 41.9, H 8.0, N 14.5 (10.4 mmol g⁻¹), Cl 23.3.

4: ¹³C-NMR (62.9 MHz, D₂O, DEPT-135): δ=49.7 (CH₂), 54.5 (CH₂), 131.4 (CH). FT-ATR-IR: δ=1110, 1164, 1331, 1392, 1554, 2826, 2941, 3291 cm⁻¹.

Elemental analysis: C 61.8, H 10.5, N 21.3 (15.2 mmol g⁻¹)

II. Derivatizations of Inventive compound 3

The synthetic availability of the secondary amines in inventive compound 3—an essential precondition for successful polymer-assisted chemistry—was investigated by means of acylation (5 and 11), nitrosylation (6) and alkylation reactions (7-9) (FIG. 2). Efficient reactions were indicated by complete removal of the NH band in the IR spectrum, the consistent increase in mass of the resins and by elemental analysis.

The ULTRA resins obtained (ULTRA resins mean in this connection the inventive resins highly loaded with reactive groups) were used to prepare polymeric reagents and for solid phase synthesis. Resin 4 can be employed directly as polymeric base with a loading of 15.2 mmol/g. Reductive amination with formaldehyde resulted in resin 7 which comprises 13.2 mmol/g reactive amino groups. Resin 8, which is suitable in particular for ion exchange, was prepared by alkylation of 7 with methyl iodide, the maximum chloride loading of the resin of 8 mmol/g being equivalent to a chlorine content of 28%. It was possible to assemble the acylation catalyst 9 from 3 by microwave-assisted synthesis at 220° C.

An ULTRA resin for solid phase synthesis (11) was obtained by attaching 4-(4′-acetoxymethyl-3′-methoxyphenoxy)butyrate (10) to the resin 3. Following complete deacetylation (IR), resin 12 was used with a loading [14] of 2.5 mmol/g for synthesizing heterocycles and peptides. The individual derivatives were obtained from inventive compound 3 by the following reagents and reaction conditions.

The following list represents a completion of FIG. 2:

a) 2 M NaOH; triethylamine, DMF. b) Ac₂O, pyridine. c) NaNO₂, HOAc, water. d) CH₂O, NaCNBH₃. e) mel. HCl, water. f) 4-chloropyridinium hydrochloride, diisopropylethylamine (DIPEA), DMF, 220° C., 10 min, microwave irradiation. g) 4-(4-acetoxymethyl-3-methoxyphenoxy)butanoic acid (10), O-(benzotriazol-1-yl)-N,N,N′,N′-tetramethyluronium tetrafluoroborate (TBTU), DIPEA, DMF (2×). h) NaOMe, MeOH.

III. Synthesis of pyrazolecarboxylic acids and peptides on linker-functionalized ULTRA resin 12

The pyrazolecarboxylic acid 14 was prepared on 12 using an unmodified method [13] which was originally developed for Wang polystyrene (FIG. 3). After three stages, which were followed by IR, starting from 5 mg of the ULTRA resin 3, 8.8 mg of the product 14 were obtained (80% purity of the crude product, 65% yield after chromatography). In order to ascertain restrictions on the product size, a series of peptides differing in length were synthesized on the ULTRA resin 12. Peptides with 7, 9, 13 and 19 amino acids were prepared in a robotic synthesizer using Fmoc-protected amino acids and activation with carbodiimide-hydroxy-benzotriazole, without incorrect sequences being detectable. The remarkable economy of the ULTRA resin is made clear in this example by the fact that 3.4 mg of the initial resin 4 were sufficient to synthesize 42 mg of resin with completely protected tridecapeptide. The crude product was obtained in excellent purity and yield (90% purity of the crude product, 78%, 13.1 mg, after preparative HPLC) by ether precipitation.

The following reagents and reaction conditions were specifically used for synthesizing pyrazole acids and peptides on the linker-functionalized ULTRA resin 12:

a) Diketene, N,N-dimethyl-4-aminopyridine (DMAP) [12]. b) 1.3 equiv. 4-trifluoromethylbenzaldehyde, DIPEA, N-methylpyrrolidin-2-one (NMP), 16 h. 2.3 equiv. 4-methylphenylhydrazinium hydrochloride. 3. DCM/HOAc, 30 min. 4. TFA/water 95:5. c) Fmoc-Gly-OH, 2-mesitylenesulfonyl-3-nitro-1H-1,2,4-triazole (MSNT), N-methylimidazole, DCM, 2× 2 h. d) 1. amino acid coupling: Fmoc-AA-OH, N,N-diisopropylcarbodiimide (DIC), 1-hydroxybenzotriazole (HOBt), DMF. 2. Deprotection of the amines: 20% piperidine, DMF. 3. TFA, water (5%), triisopropylsilane (2.5%), ethanedithiol (2.5%).

The synthesized compounds 14 and 16 were characterizable as follows:

14: ¹H-NMR (250 MHz, CDCl₃): δ=2.36 (s, 3H, PhMe), 2.52 (s, 3 H, 5-Me), 7.25 (dd, 4H, 1-Ph), 7.60, 7.78 (2 d, 4H, 3-Ph) . Calculated (C₁₉H₁₅F₃N₂O₂): 360.33 Da, found (ESI-MS, pos. mode): 361.0 m/z; (ESI-MS, neg. mode) 359.0 m/z.

16: Calculated (C₆₀H₈₇N₁₉O₂₀S₁): 1425.61 Da, found (ESI-MS, pos. mode): 1426.6 m/z.

IV. Synthesis of a hydrazone ultra resin and use as scavenger of electrophiles

The unfunctionalized amine-resin can be converted into a hydrazone-resin. The following synthetic sequence is preferably used for this purpose: Reaction with an excess of N-Boc-3-(4-cyanophenyl)oxaziridine in dichloromethane at room temperature. The Boc-hydrazine-resin was obtained with a loading of 4.6 mmol/g. Boc elimination by trifluoroacetic acid in dichloromethane affords the hydrazine-resin as trifluoroacetate salt. Washing with triethylamine results in a basic hydrazine-resin with a loading of 8.6 mmol/g. The resulting hydrazine-resin is suitable for removing excess reagents from a reaction solution, especially acid chlorides, isocyanates, aldehydes, ketones and other electrophiles.

For example, 4-nitrobenzaldehyde is completely removed from dichloromethane by 2 equivalents of the resin after 2 hours.

Alternatively, the hydrazine-resin is obtained by nitrosation (sodium nitrite, HCl) followed by reduction with lithium aluminum hydride.

V. Example of a polymeric reagent based on an ion exchanger: borane-resin for polymer-assisted reduction reactions

The unfunctionalized ultra resin is converted by alkylation with methyl iodide at RT into the tetraalkylammonium iodide-resin. The borohydride-resin is obtained in a loading of 8-9 mmol/g by an exchange reaction with aqueous sodium borohydride solution. The resin is particularly suitable for reducing aldehydes and ketones, for example for reducing cinnamaldehyde to cinnamyl alcohol (4 eq., 2 h, complete reduction to cinnamyl alcohol).

VI. Use of ultra resins as supports for polymeric reagents

Covalent polymeric reagents were synthesized on ultra resins and used for reactions in solution. A p-dialkyl-pyridine resin was prepared as acylation catalyst. For this purpose, 4-chloropyridinium hydrochloride was heated with triethylamine in DMF at 220° C. for 10 min (microwave). For acylation reactions, a resin which can be activated in analogy to pentafluorophenol was obtained from 4-hydroxytetrafluorobenzoic acid with O-(benzotriazol-1-yl)-N,N,N′,N′-tetramethyluronium tetrafluoroborate (TBTU) as condensing agent.

### LITERATURE DETAILS AND NOTES

[1] a) R. B. Merrifield, J. Am. Chem. Soc. 1963, 85, 2149-2151; b) F. Zaragoza Dorwald, Solid-Phase Synthesis, Wiley-VCH, Weinheim 2000; c) D. Hudson, J. Comb. Chem. 1999, 1, 333-360, 403-457.
[2] a) Combinatorial chemistry—Synthesis, analysis, screening, (ed.: G. Jung) Wiley-VCH, Weinheim 1999; b) Combinatorial peptide and nonpeptide libraries, (ed.: G. Jung) VCH, Weinheim 1996.

[3] a) S. V. Ley, I. R. Baxendale, R. M. Bream, P. S. Jackson, A. G. Leach, D. A. Longbottom, M. Nesi, J. S. Scott, R. I. Storer, S. J. Taylor, J. Chem. Soc. Perkin Trans. 1, 2000, 23, 3815-4195; b) A. Kirschning, H. Monenschein, R. Wittenberg, Angew. Chem. 2001, 113, 670-701; Angew. Chem. Int. Ed. 2001, 40, 650-679; c) J. Rademann, J. Smerdka, G. Jung, P. Grosche, D. Schmid, Angew. Chem. 2001, 113, 390-393; Angew. Chem. Int. Ed. 2001, 40, 381-385; d) J. Rademann, W. Kraas, B. Dörner, Nachrichten Chem. 2000, 48, 280-283; e) S. Weik, G. Nicholson, G. Jung, J. Rademann, Angew. Chem. 2001, 113, 1489-1492; Angew. Chem. Int. Ed. 2001, 40, 1436-1439; f) G. Sorg, A. Mengel, G. Jung, J. Rademann, Angew. Chem. 2001, 113, 4532-4535; Angew. Chem. Int. Ed. 2001, 40, 4395-4397.
[4] D. C. Sherrington, Chem. Commun. 1998, 2275-2286.
[5] W. Rapp, L. Zhang, R. Häbish, E. Bayer, in Peptides 1988, Proc. Eur. Pept. Symp., ed.: G. Jung, E. Bayer, Walter de Gruyter, Berlin, 1989, pp. 199-201.
[6] a) M. Meldal, Tetrahedron Lett. 1992, 33, 3077-3080; b) J. Rademann, M. Meldal, K. Bock, Chem. Eur. J. 1999, 5, 1218-1225; c) J. Rademann, M. Groetli, M. Meldal, K. Bock, J. Am. Chem. Soc. 1999, 121, 5459-5465; d) T. Groth, M. Grøtli, L. P. Miranda, W. D. Lubell, M. Meldal, J. Chem. Soc., Perkin Trans. I 2000, 4258-4264.
[7] B. M. Trost, Angew. Chem. 1991, 107, 285-307; Angew. Chem. Int. Ed. 1991, 30, 214-234.
[8] Conventional resins have loadings between 0.2 and 1 mmolg⁻¹. The loading can be increased by synthesizing dendrimers or by graft polymerization. V. Swali, N. J. Wells, G. J. Langley, M. Bradley, J. Org. Chem. 1997, 63, 4902-4903; C. W. Lindsey, J. C. Hodges, D. M. Leonard, G. F. Filzen, J. Comb. Chem. 2000, 2, 550-559.
[9] J. Rademann, M. Barth, R. Brock, H. -J. Egelhaaf, G. Jung, Chem. Eur. J., 2001, 7, 3884-3889.
[10] Branched PEI is used as process chemical in the paper industry and is prepared in kt quantities by cationic polymerization of aziridine. Branched polyethyleneimine have been crosslinked for ion exchange and for enzyme immobilization: a) Shepperd J. Chem. Soc. 1957, 86-. b) G. Manecke, S. Heydolph, Makromol. Chem. 1981, 182, 2641-2657.
[11] The stability of the resin was investigated under strongly basic (10% NaOH) and strongly acidic reaction conditions (37% HCl) and at 220° C. (DMF, microwave irradiation) without a modification in the structure and morphology of the resin being observed.
[12] The swelling volumes were determined by compressing swollen resin samples in a 5 ml syringe with a weight of 2 kg by measuring the resin volume after the pressure had acted.
[13] P. Grosche, A. Höltzel, T. B. Walk, A. W. Trautwein, G. Jung, Synthesis 1999, 1961-1970.
[14] The loading of hydroxy-resins was by attaching Fmoc-Gly-OH using the method described in ref. 14, followed by Fmoc elimination and spectrophotometric determination at 267, 289 and 301 nm.

1. A polymeric compound composed of linear polymer chains having the general formula
—[R—X]ₙ—
in which R is a hydrocarbon group, and X is a group having at least one heteroatom, where the linear polymer chains are crosslinked together via linking groups.

2. The polymeric compound as claimed in claim 1, characterized in that it is a substantially insoluble, swellable resin.

3. The polymeric compound as claimed in claim 1, characterized in that the linking groups crosslink the linear polymer chains via their heteroatoms.

4. The polymeric compound as claimed in claim 1, characterized in that only some, preferably less than 30%, more preferably less than 15%, in particular about 12%, of the heteroatoms are connected to linking groups, and most of the remaining heteroatoms are available for further derivatizations.

5. The polymeric compound as claimed in claim 1, characterized in that R is an alkyl group, preferably a C₁-C₆-alkyl group, in particular a linear alkyl group.

6. The polymeric compound as claimed in claim 1, characterized in that R is an ethylene group.

7. The polymeric compound as claimed in claim 1, characterized in that X is selected from the group consisting of NH, N—R¹, CH—NH₂, CR—OH, CH—R²—OH, in particular NH, in which R¹ and R² are selected from the group consisting of alkyl, cycloalkyl, aryl and benzyl.

8. The polymeric compound as claimed in claim 1, characterized in that X is selected from the group consisting of N⁺—R¹R², O, S, CH—R²—NH₂, CH—SH, CH—R²—SH, in which R¹ and R² are selected from the group consisting of alkyl, cycloalkyl, aryl and benzyl.

9. The polymeric compound as claimed in claim 7, characterized in that R² is a C₁-C₆-alkyl group, preferably a methylene group.

10. The polymeric compound as claimed in claim 1, characterized in that the polymer chains are polyethyleneimine chains.

11. The polymeric compound as claimed in claim 1, characterized in that the polymer chains are polyvinylamine chains.

12. The polymeric compound as claimed in claim 1, characterized in that the linking groups are derived from at least one compound selected from the group consisting of polyaldehydes, activated polycarboxylic acids, isocyanates, isothiocyanates, dihalides, epoxides, ketenes and epichlorohydrin.

13. The polymeric compound as claimed in claim 12, characterized in that the linking groups are derived from at least one polyaldehyde, preferably from at least one aromatic polyaldehyde.

14. The polymeric compound as claimed in claim 1, characterized in that the linking groups are derived from a dialdehyde, preferably from an aromatic dialdehyde, in particular from terephthalaldehyde.

15. The polymeric compound as claimed in claim 1, characterized in that it is composed of linear polyethyleneimine crosslinked with terephthalaldehyde.

16. The polymeric compound as claimed in claim 12, characterized in that the linking groups are derived from at least one dihalide, preferably from a dihalide of the group 1,4-dibromomethylbenzene, 1,4-dichloromethylbenzene, 1,6-dibromo(dichloro)hexane, and 1,7-dibromo(dichloro)heptane.

17. The polymeric compound as claimed in claim 1, characterized in that it has a loading with amino functionalities of about 10 to about 25 mmol/g, preferably about 15 mmol/g.

18. The polymeric compound as claimed in claim 1, characterized in that it is in the form of resin micropellets.

19. The use of a polymeric compound as claimed in claim 1 for solid phase synthesis.

20. The use as claimed in claim 19 for synthesizing peptides and proteins.

21. The use as claimed in claim 19 for synthesizing heterocycles.

22. The use of a polymeric compound as claimed in claim 1 for polymer-assisted synthesis in solution.

23. The use as claimed in claim 22 for preparing polymeric reagents.

24. The use as claimed in claim 22 for preparing an ion exchanger.

25. The use of a polymeric compound as claimed in claim 1 for immobilizing enzymes.

26. The use of a polymeric compound as claimed in claim 1 for immobilizing substrates which are converted with an enzyme.

27. The use of a polymeric compound as claimed in claim 1 as carrier for pharmacological active ingredients.

28. The use of a polymeric compound as claimed in claim 1 for inducing an immune response.

29. The use of a polymeric compound as claimed in claim 1 as scavenger of electrophiles, in particular of acid chlorides and isocyanates.

30. A method for solid phase synthesis, characterized in that a polymeric compound as claimed in claim 1 is provided with a suitable linker, and then the compound to be synthesized is assembled stepwise on this linker.
